(19) United States
(12) Patent Application Publication
(10) Pub. No.: US 2008/0283333 A1
(43) Pub. Date: Nov. 20, 2008

(54) 911 Firejumper a movable strand descending and repelling device

(76) Inventor: Linda L. Long, Morganton, GA (US)

Correspondence Address: Linda L. Long, 9881 Old Highway 76, Morganton, GA, 30560, US

(21) Appl. No.: 11/804,277

(22) Filed: May 17, 2007

(51) Int. Cl. A62B 1/16

(52) U.S. Cl. 182/7; 182/230

(57) ABSTRACT

The 911 Firejumper is a fixed base moving strand descending device specifically for the purpose of descent in emergencies, such as fire, earthquake, or other obstruction of the common escape. It may also be used as a repelling device for rescue personnel in a variety of ways using rescue vehicles. A mesh seat, folded inside the base, pulled into the window by use of an affixed cord on the outside of the window, secured around a person, or persons and lowered by the device to within two feet of the ground, utilizing brakes within the base activated by the weight of the person, or persons allowing safe descent at a speed directly related to the weight applied thereto.

### DESCRIPTION AND OPERATION

The base of the Firejumper is made in one solid piece. It is made of stainless steel to prevent rusting and give it more strength. It is attached to the wall above the window of the building with large lag bolts which will secure the strength that is needed to carry at least 600 lbs of weight with each jump.

The base is made with a distance lip below the door of the device which distances the belt at varying distances from the wall according to the floor of the building onto which it is placed. The lip is designed to prevent the prevent the person who is in the seat from coming too close to the wall of the building during descent. For higher buildings where there is more wind force the lip must be further out from the wall. An exit shoot for the belt could replace the lip, but would be more difficult to decorate to look ornate on the building.

The inside of the base has an inserted lower rotating cylinder which floats on a sealed ball bearing onto which the belt is attached. There are two raised smooth areas onto which the brakes are set around and onto which the upper brake rests during descent. The belt is attached by rivets or screws and a metal plate to hold it fast. The belt rolls smoothly around the cylinder because the belt is flat and strong and made with a material that is fireproof. There is not a factor of rusting or tangling and twisting of the belt with this design. Its' smooth surface won't catch onto anything to hang up.

The upper cylinder is placed in a shaft with a slip spring to prevent the cylinder from dropping down until a weight is applied; this protects the brake from sticking over time not used. The upper cylinder is rounding and smooth on the top and flat on the bottom. This cylinder does not turn. It holds two brakes that are attached on both sides. The brakes are designed not to touch the belt, only the raised areas with braking on the lower cylinder, which are designed with a texture that will allow the slowing of the descent without ever coming to a complete stop.

The belt rolls toward the back of the base and wraps around in an “S” shape to the front and over the upper cylinder. When a weight is placed on the belt the top cylinder comes down causing the slip spring to flatten. The upper brakes engage with the lower cylinder brakes on either side, giving a slow descent according to the weight applied.

The seat must be made of a fireproof mess material that allows airflow. It is essential that the seat be attached to the belt effectively to prevent tearing during the descent. The parts assure a strong attachment if the belt is folded for strength.

There are two sets of hooks for the seat. The inner hooks for smaller people and the outer hooks for larger people. They allow for double hooking in case a parent should want to ride down with a child. They use a stainless steel hook clip for a secure hold.

It is recommended that children be completely cocooned into the seat to prevent them from unhooking the seat during the descent.

The outer cover base completely covers the base and is also attached with the same lag bolts as the base. It contains a spring loaded door which will automatically open when the cord hook from the seat is pulled. The seat of the FireJumper must be folded carefully into the bottom of the outer base cover to prevent its' hanging up when it is pulled down.

The Window Hook is attached to the side of the window at around the waist level or on the side of the window sill outside the window. Take the hook off of the attachment and pull it into the window. Bring the attached seat between the legs and unfold. Hook the seat above the shoulders and continue hooking down to the legs securely to provide a firm hold. Make sure all hooks are attached securely and the belt is straight. Climb onto the window sill and jump.

### BRIEF DESCRIPTION

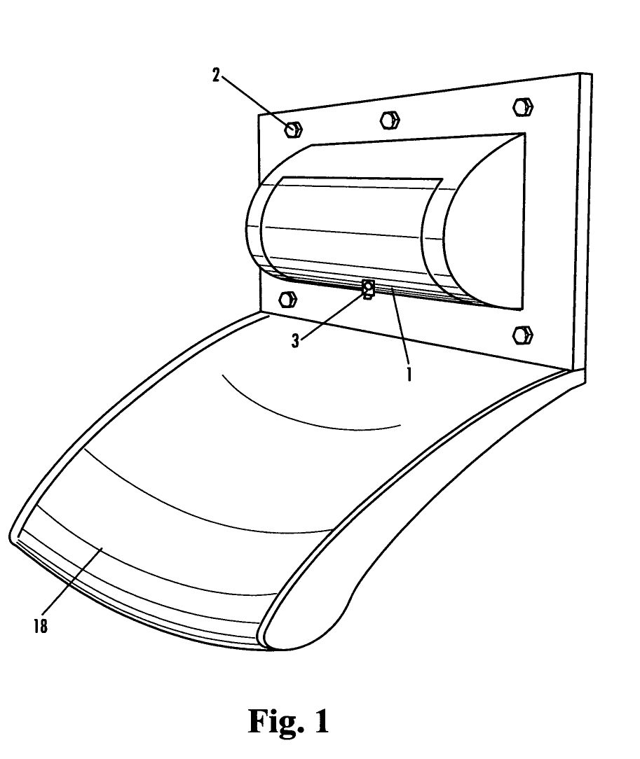

FIG. 1: Shows the front of the FireJumper as it appears over a window except for the cord that attaches to the seat and passes through the spring closure (part # 3) The base is underneath the lighter weight base cover (#'s 1) and both are attached to the wall together with lag bolts (Parts # 2) to hold it secure. (Part # 15) is the spring loaded door from the front. The convex distance lip (part # 18) is in evidence where it protrudes from the inner base underneath the base cover.

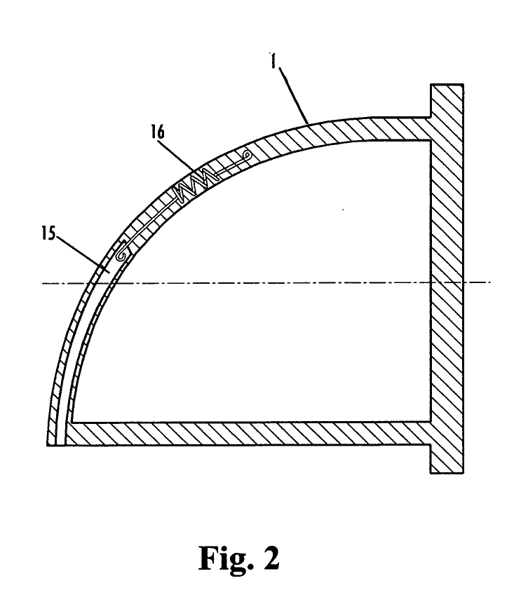

FIG. 2: Shows the side view of the spring (part # 15) and the spring loaded door (part # 16).

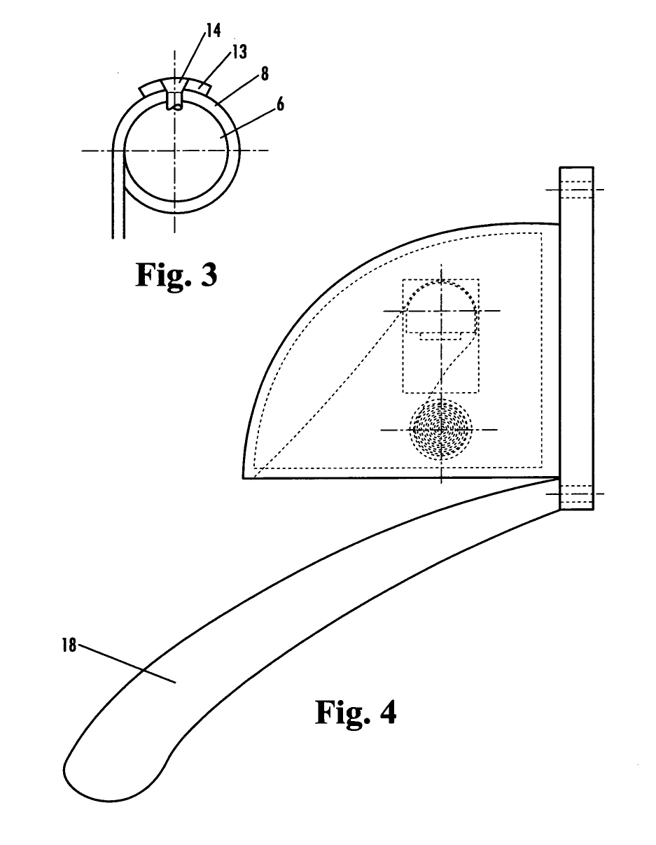

FIG. 3: Shows a left side view of the lower cylinder (part #6) with the belt (part # 8) wrapped around toward the back, the stainless steel retaining plate (part # 13 and the stainless steel rivet or countersunk screw that holds it in place.

FIG. 4: Shows the right view of the inner cylinders with the belt around the upper cylinder (part # 4) and the shaft into which it is inserted. Also the side view of the distance lip (part # 18).

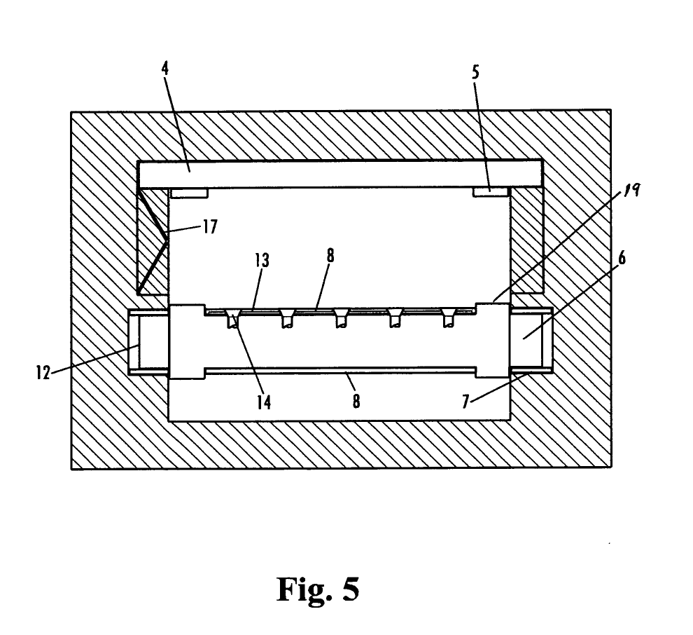

FIG. 5: Shows a font view of the base (part #1) with the lower cylinder (part # 6) with the raised braking area on either side (part # 19) the belt (part # 8) with the retaining plate (part # 13) and the rivets or screws (parts # 14). Also the slot (part # 7) into which the lower cylinder is placed after the sealed ball bearing (parts # 12) are placed onto the cylinder ends. The upper cylinder (part #4) is seen in the shaft into which it is inserted and the slip spring (part # 17) that hold it in place until weight is applied. The upper brakes (parts # 5) are seen on either side of the upper cylinder.

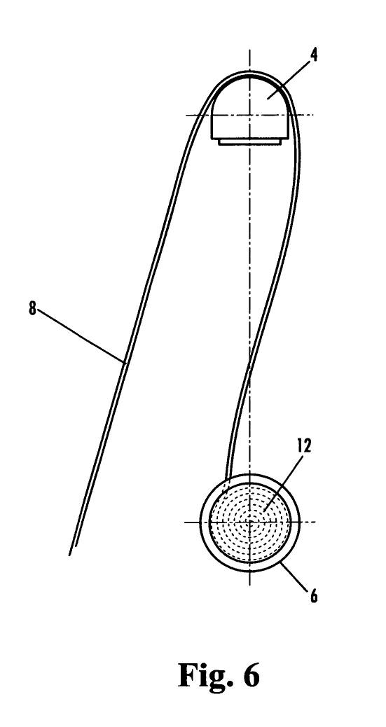

FIG. 6: Shows the side view of both upper and lower cylinders parts # 4 & 6 with the belt (Part # 8) and the sealed balled bearings (part # 12).

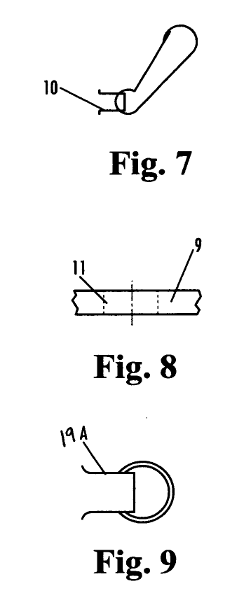

FIG. 7: Shows the stainless steel hook clip for the seat (part # 10).

FIG. 8: Shows the inner seat loop (part # 11) for the hook clip.

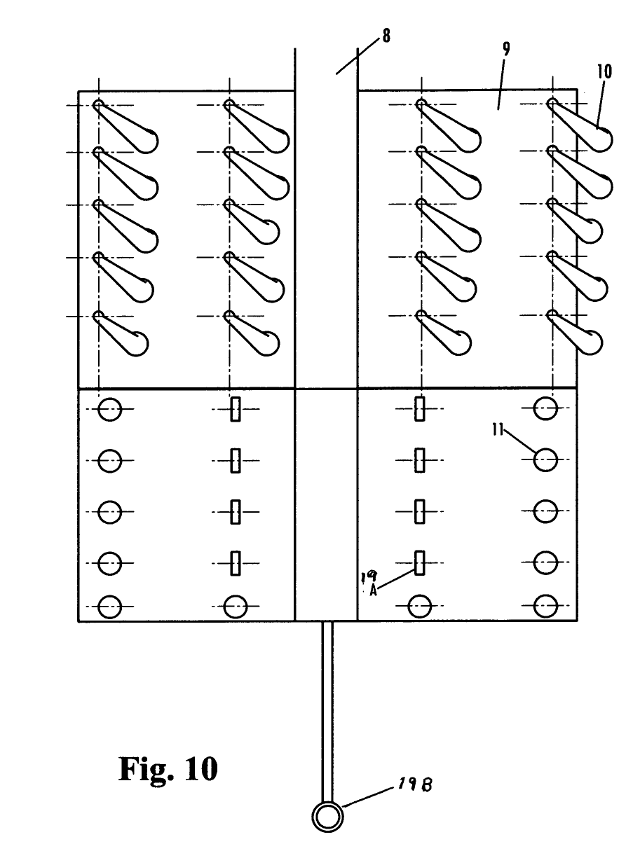

FIG. 9: Shows the stainless steel hook (part #A) on the outer seat for the hook clip.

FIG. 10: Shows the seat (part #9) intact with the belt and all the hooks (Parts# 11 & A) and clips (parts # 10) in place. The belt (part # 8) that is sewn completely thorough the solid mesh seat and is attached to the pull cord (part # B) that comes through the door spring to open the spring loaded door. This is the cord that is attached to the side of the window and gives access to the seat that is folded and placed inside the spring loaded door.
1) Base/outer base cover
2) Lag Bolts
3) Spring Closure
4) Upper Cylinder
5) Brake
6) Lower Cylinder
7) Cylinder Slot in base
8) Belt
9) Seat
10) Stainless Steel Hook Clamp
11) Loop for hook inner seat
12) Sealed Ball Bearing
13) Stainless Steel Retaining Plate
14) Stainless Steel Holing Screw or Rivet
15) Spring Loaded Door
16) Door spring
17) Slip Spring
18) Distance Lip
19) Raised Areas on Lower Cylinder for Braking A) Stainless steel Hook for in outer Seat B) Window Hook to Attach form Window to Access Seat

I claim:

1. The 911 Firejumper is a moving strand descending device and a safe escape at a time of danger due to the obstruction of common exits in a home or commercial building with multiple floors.

2. The 911 Firejumper can and should be adapted to use in rescue vehicles and helicopters and even exits from planes or other movable structures.

3. The 911 Firejumper will be very useful to the military and homeland security.
